(19) United States
(12) Patent Application Publication
(10) Pub. No.: US 2017/0372087 A1
(43) Pub. Date: Dec. 28, 2017

(54) METHOD AND SYSTEM FOR DATA MANAGEMENT

(71) Applicant: LINE Corporation, Tokyo (JP)

(72) Inventor: Seokchan LEE, Seongnam-si (KR)

(73) Assignee: LINE Corporation, Tokyo (JP)

(21) Appl. No.: 15/630,125

(22) Filed: Jun. 22, 2017

(30) Foreign Application Priority Data
Jun. 28, 2016 (KR) 10-2016-0080551

(51) Int. Cl. G06F 21/62; G06F 21/60; H04L 9/08; H04L 29/06

(52) U.S. Cl. CPC G06F 21/62; G06F 21/6218; H04L 9/0863; G06F 21/602; H04L 63/083; H04L 9/08

(57) ABSTRACT

Provided is a data management method and system. A data management method executed by an electronic device configured as a computer may include setting a first password for allowing access to data stored on the electronic device; setting a second password for deleting the data or blocking access to the data; providing a user interface for inputting a password; and processing the input password by allowing access to the data in response to an input of the first password through the user interface or by deleting the data or blocking access to the data in response to an input of the second password through the user interface.

### CROSS-REFERENCE TO RELATED APPLICATION(S)

This application claims priority under 35 U.S.C. §119 to Korean Patent Application No. 10-2016-0080551 filed on Jun. 28, 2016, in the Korean Intellectual Property Office (KIPO), the entire contents of which are incorporated herein by reference.

### BACKGROUND

### Field

One or more example embodiments relate to a data management method and/or system.

### Description of Related Art

A variety of related arts relate to technology for verifying a right to use an electronic device, verifying a right to execute a specific application installed on the electronic device, or verifying a right to access data stored on the electronic device. For example, Korean Patent Registration No. 10-1366120 relates to a method of setting a password using a pattern, and discloses a method of setting a password by applying a pattern as a password in various environments that require an input of the password.

A password may be provided in various forms, such as a number, a character, a special character, a pattern, a combination thereof, and the like. Only a user authorized using the password may be allowed to access an electronic device, a specific application, or data. Thus, data, for example, personal information, may be protected.

However, in the related art, data may not be protected in a coercive situation in which the user is to disclose a password by external coercion. For example, if further great damage may be caused by data leakage due to such coercion, the data may need to be deleted. Alternatively, if a password is to be input due to coercion, there is a need to protect the data not to be leaked.

### SUMMARY

One or more example embodiments provide a data management method and system that may set a first password for allowing access to an electronic device, a specific application, or specific data and a second password for deleting specific data desired to be protected or blocking access to the specific data, and may delete the specific data or block access to the specific data in response to an input of the second password, and may protect data using the second password in a coercive situation in which a user is to disclose a password.

At least one example embodiment provides a non-transitory computer-readable recording medium storing instructions that, when executed by a processor, cause the processor to perform a data management method in conjunction with an electronic device configured as a computer, the method including setting a first password for allowing access to data stored on the electronic device, setting a second password for deleting the data or blocking access to the data; providing a user interface for inputting a password, and processing the input password by allowing access to the data in response to an input of the first password through the user interface or by deleting the data or blocking access to the data in response to an input of the second password through the user interface.

At least one example embodiment also provides a data management method executed by an electronic device configured as a computer. The method including setting a first password for allowing access to data stored on the electronic device, setting a second password for deleting the data or blocking access to the data, providing a user interface for inputting a password, and processing the input password by allowing access to the data in response to an input of the first password through the user interface or by deleting the data or blocking access to the data in response to an input of the second password through the user interface.

According to some example embodiments, it is possible to protect data using a second password even in a coercive situation in which a user is to disclose a password by setting a first password for allowing access to an electronic device, a specific application, or specific data and the second password for deleting specific data desired to be protected and blocking access to the specific data, and by deleting the specific data or blocking access to the specific data in response to an input of the second password.

A data management system according to example embodiments may be configured through an electronic device and a data management method according to example embodiments may be performed through the electronic device. The electronic device according to example embodiments may refer to any type of devices capable of controlling access to the electronic device, access to an application installed on the electronic device, or access to specific data stored on the electronic device using a first password that is set in various forms, such as a number, a character, a special character, a pattern, or a combination thereof. For example, the electronic device may control access to the electronic device so that a function of the electronic device is available only in response to an input of the first password. As another example, the electronic device may control access to a specific application so that the specific application may be executed only in response to an input of the first password. As another example, the electronic device may control access to data so that data stored on the electronic device is accessible only in response to an input of the first password.

A second password may be set to the electronic device in addition to the first password. The second password may be set for another purpose. For example, when the second password is input through a user interface, a function for blocking access to the data may be executed and data stored on the electronic device may be protected. In this case, access to the electronic device may be allowed, the function of the electronic device may be used, however, the data may be deleted or access to the data may be blocked, so that the data may be securely protected. Similarly, when the second password is input through the user interface, a function for deleting data stored on the electronic device or blocking access to the data may be executed on the electronic device. In this case, although access to the specific application may be allowed, the data itself may be deleted or access thereto may be blocked. Thus, the data may be protected. For example, if data is deleted in response to the input of the second password, access to the data may be fundamentally blocked, which may lead to preventing the leakage of data. As another example, data may be secured by encrypting the data using a specific key capable of encrypting and decrypting the data. In this case, access to encrypted data may be blocked by deleting the specific key for encryption and decryption in response to an input of the second password. Accordingly, the data may be protected.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Example embodiments will be described in more detail with regard to the figures, wherein like reference numerals refer to like parts throughout the various figures unless otherwise specified, and wherein:

FIG. 1 is a diagram illustrating an example of a configuration of an electronic device according to at least one example embodiment;

FIG. 2 is a block diagram illustrating an example of components included in a processor of an electronic device according to at least one example embodiment;

FIG. 3 is a flowchart illustrating an example of a method performed by an electronic device according to at least one example embodiment;

FIG. 4 illustrates a first example of protecting data by deleting the data according to at least one example embodiment;

FIG. 5 illustrates a second example of protecting data by deleting the data according to at least one example embodiment;

FIG. 6 illustrates a third example of protecting data by deleting the data according to at least one example embodiment;

FIG. 7 illustrates an example of a process of allowing access to data according to at least one example embodiment;

FIG. 8 illustrates an example of a process of blocking access to data according to at least one example embodiment;

FIG. 9 illustrates an example of a result value backup process according to at least one example embodiment;

FIG. 10 illustrates an example of a process of blocking access to data using a pair of a public key and a private key according to at least one example embodiment;

FIG. 11 illustrates an example of a process of blocking access to data by deleting a key according to at least one example embodiment;

FIG. 12 illustrates an example of a key backup process according to at least one example embodiment;

FIG. 13 illustrates an example of a process of encrypting a key using a public key and a private key according to at least one example embodiment;

FIG. 14 illustrates an example of a password input screen and a virtual screen according to at least one example embodiment;

FIG. 15 illustrates an example of deleting a portion of data according to at least one example embodiment; and

FIG. 16 illustrates an example of using a plurality of second passwords according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

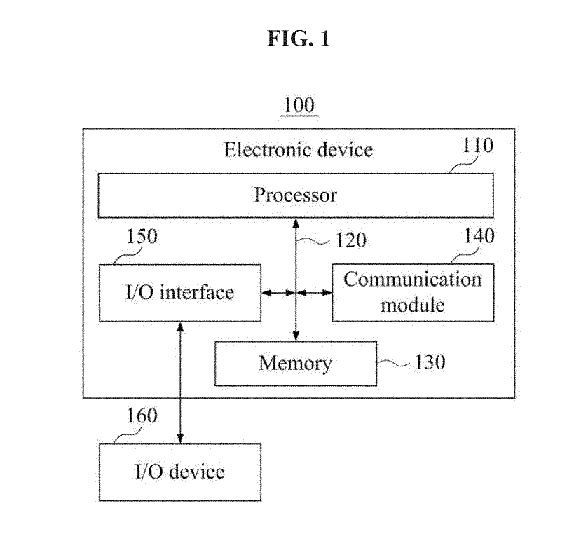

FIG. 1 illustrates an example of a configuration of an electronic device according to at least one example embodiment. Referring to FIG. 1, an electronic device 100 may include a processor 110, a bus 120, a memory 130, a communication module 140, and an input/output (I/O) interface 150.

The electronic device may be a fixed terminal or a mobile terminal configured as a computer device. For example, the electronic device may be a smartphone, a mobile phone, navigation, a computer, a laptop computer, a digital broadcasting terminal, a personal digital assistant (PDA), a portable multimedia player (PMP), a tablet personal computer (PC), and the like, and may include at least one processor, at least one memory, and a permanent storage for storing data.

The processor 110 may be configured to process computer-readable instructions by performing basic arithmetic operations, logic operations, and I/O operations. The computer-readable instructions may be provided from the memory 130 and/or the communication module 140 to the processor 110. For example, the processor 110 may be configured to execute received instructions in response to the program code stored on the storage device, such as the memory 130.

The bus 120 enables communication and data transmission between components of the electronic device 100. For example, the bus 120 may be configured using a high-speed serial bus, a parallel bus, a storage area network (SAN) and/or another appropriate communication technique.

The memory 130 may include a permanent mass storage device, such as random access memory (RAM), read only memory (ROM), a disk drive, etc., as a computer-readable storage medium. Here, ROM and a permanent mass storage device may be included as a separate permanent storage separate from the memory 130. Also, an OS and at least one program code, for example, a code for a browser installed and executed on the electronic device 100 or an application installed and executed on the electronic device 100 for providing a specific service, may be stored in the memory 130. Such software components may be loaded from another computer-readable storage medium separate from the memory 130 using a drive mechanism. The other computer-readable storage medium may include, for example, a floppy drive, a disk, a tape, a DVD/CD-ROM drive, a memory card, etc. According to other example embodiments, software components may be loaded to the memory 130 through the communication module 140, instead of, or in addition to, the computer-readable storage medium. For example, at least one program may be loaded to the memory 130 based on a program, for example, the application, installed by files provided over the network from developers or a file distribution system that provides an installation file of the application.

The communication module 140 may be a computer hardware component for connecting the electronic device 110 to a computer network. For example, the communication module 140 may provide a function for communication between the electronic device 100 and another electronic device over the network. Here, a communication scheme using the computer network is not particularly limited and may include a communication scheme that uses a near field communication between devices as well as a communication scheme using a communication network, for example, a mobile communication network, the wired Internet, the wireless Internet, and a broadcasting network. For example, the computer network may include at least one of network topologies that include networks, for example, a personal area network (PAN), a local area network (LAN), a campus area network (CAN), a metropolitan area network (MAN), a wide area network (WAN), a broadband network (BBN), the Internet, and the like. Also, the computer network may include at least one of a bus network, a star network, a ring network, a mesh network, a star-bus network, a tree or hierarchical network, and the like. However, it is only an example and the example embodiments are not limited thereto.

The I/O interface 150 may be a device used to interface with the I/O device 160. For example, the input device may include a keyboard, a mouse, etc., and an output device may include a device, such as a display for displaying a communication session of an application. As another example, the I/O interface 150 may be a device for interface with an apparatus in which an input function and an output function are integrated into a single function, such as a touch screen. Depending on example embodiments, the I/O device 160 may be configured into a single apparatus with the electronic device 100. In detail, when processing instructions of the computer program loaded to the memory 130, the processor 110 of the electronic device 100 may control the electronic device 100 to display a configured service screen or content on an output device, such as a display, through the I/O interface 150.

According to other example embodiments, the electronic device 100 may include a greater or lesser number of components than the number of components shown in FIG. 1. However, there is no need to clearly illustrate many components according to the related art. For example, the electronic device 100 may include at least a portion of the I/O device 160, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera, various physical buttons, a button using a touch panel, an I/O port, a vibrator for vibration, etc., which are generally included in the smartphone.

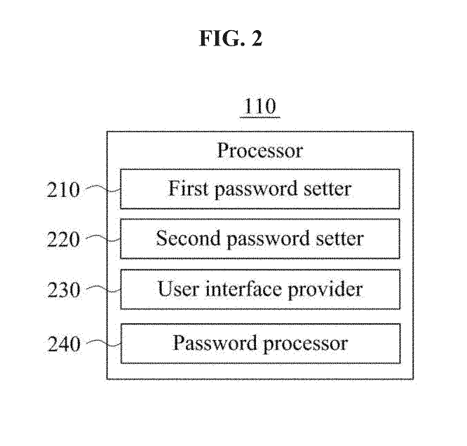

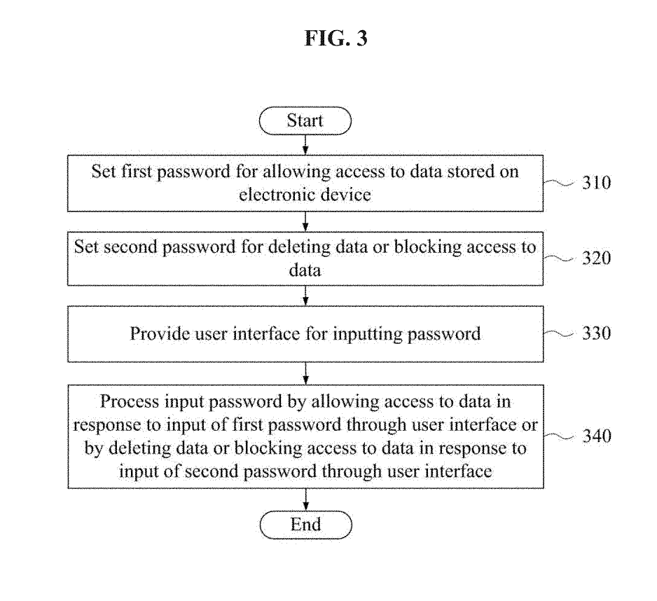

FIG. 2 is a block diagram illustrating an example of components includable in a processor of an electronic device according to at least one example embodiment, and FIG. 3 is a flowchart illustrating an example of a method performed by an electronic device according to at least one example embodiment. A data management system according to example embodiment may be configured on the electronic device 100. To this end, referring to FIG. 2, the processor 110 of the electronic device 100 may include a first password setter 210, a second password setter 220, a user interface provider 230, and a password processor 240. Here, components of the processor 110 may be representations of different functions of the processor 110 that are performed by the processor 110 in response to an instruction provided from a code stored on the electronic device 100. The processor 110 and the components of the processor 110 may be configured to execute an instruction according to a code of at least one program or a code of the OS included in the memory 130. In particular, the processor 110 and the components of the processor 110 may control the electronic device 100 to perform operations 310 through 340 included in the data management method of FIG. 3.

In operation 310, the first password setter 210 may set a first password for allowing access to data stored on the electronic device 100. For example, the first password setter 210 may control the electronic device 100 to provide a user interface for receiving and registering the first password, and may control the electronic device 100 to register a value, for example, a number, a character, a special character, a pattern, and/or a combination thereof, input through the user interface as the first password.

For example, the first password may include a password for allowing access to data by releasing a screen lock function of the electronic device 100 and by allowing use of the electronic device 100, a password by allowing access to the data by releasing a lock function of a specific application installed on the electronic device 100 and by allowing execution of the specific application, or a password for allowing a direct access to the data.

In operation 320, the second password setter 220 may set a second password for deleting the data or blocking access to the data. Similar to operation 310, the second password setter 220 may control the electronic device 100 to provide a user interface for receiving and registering the second password and may control the electronic device 100 to register a value, for example, a number, a character, a special character, a pattern, and/or a combination thereof, input through the user interface as the second password.

In operation 330, the user interface provider 230 may provide a user interface for inputting a password. For example, the user interface provider 230 may control the electronic device 100 to provide a preset user interface to receive a password for releasing the screen lock function of the electronic device 100. As another example, the user interface provider 230 may control the electronic device 100 to provide a preset user interface to receive a password for releasing the lock function of a specific application desired to be executed. As another example, the user interface provider 230 may control the electronic device 100 to provide a preset user interface to receive a password for allowing the direct access to data, such as a specific file.

In operation 340, the password processor 240 may process the input password by allowing access to the data in response to an input of the first password through the user interface or by deleting the data or blocking access to the data in response to an input of the second password through the user interface.

According to an example embodiment, in response to an input of the first password through the user interface for releasing the screen lock function of the electronic device 100, the password processor 240 may allow access to the data by releasing the screen lock function of the electronic device 100. In response to an input of the second password through the user interface for releasing the screen lock function of the electronic device 100, the password processor 240 may manage data to be inaccessible through the electronic device 100 by releasing the screen lock function of the electronic device 100 in a state in which the data is deleted or access to the data is blocked.

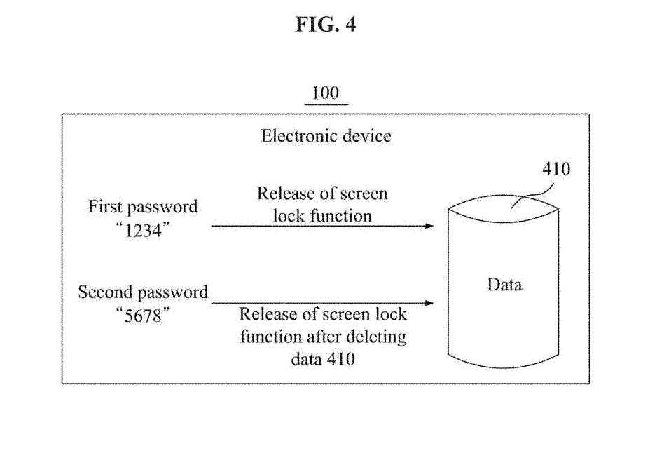

FIG. 4 illustrates a first example of protecting data by deleting the data according to at least one example embodiment. FIG. 4 illustrates an example of the electronic device 100 on which data 410 is stored. Referring to the example of FIG. 4, to release a screen lock function of the electronic device 100, “1234” is set as a first password and “5678” is set as a second password.

If a password input to release the screen lock function is “1234”, the electronic device 100 releases the screen lock function of the electronic device 100 and allows access to the data 410. On the contrary, if the password input to release a lock function of a corresponding application is “5678”, the electronic device 100 may delete the data 410 and then release the screen lock function. In this case, since the data 410 is deleted from the electronic device 100, the data 410 to be accessed may be absent even after releasing the screen lock function. Accordingly, leakage of the data 410 may be prevented.

According to another example embodiment, if the first password is input through a user interface for releasing a lock function of a specific application, the password processor 240 may allow access to data managed in the specific application by releasing the lock function of the specific application and by allowing execution of the specific application. If the second password is input through the user interface for releasing the lock function of the specific application, the password processor 240 may manage data to be inaccessible through the specific application by releasing the lock function of the specific application in a state in which the data is deleted or access to the data is blocked. In this case, the input data may be processed under control of the corresponding application.

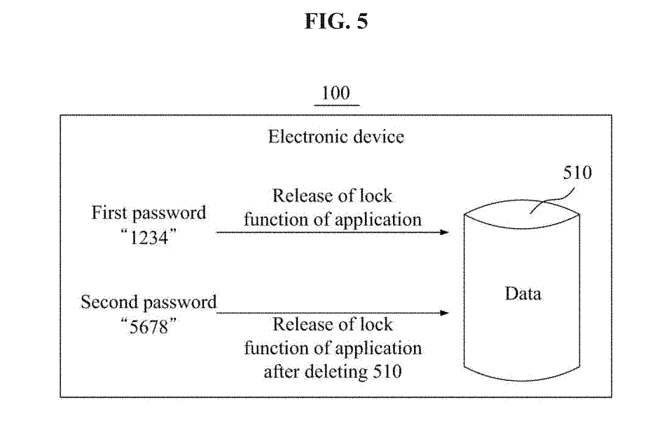

FIG. 5 illustrates a second example of protecting data by deleting the data according to at least one example embodiment. FIG. 5 illustrates an example of the electronic device 100 on which data 510 is stored. Referring to the example of FIG. 5, to release a lock function of a specific application installed on the electronic device 100, “1234” is set as a first password and “5678” is set as a second password.

If a password input to release a lock function of a corresponding application is “1234”, the electronic device 100 allows execution of the application and allows access to the data 510 through the executed application. On the contrary, if the password input to release the lock function of the application is “5678”, the electronic device 100 may delete the data 510 and then release the lock function of the application. In this case, since the data 510 is deleted from the electronic device 100, the data 510 to be accessed may be absent even after releasing the lock function of the application. Accordingly, leakage of the data 510 may be prevented.

According to another example embodiment, if the first password is input through a user interface for releasing a direct access to specific data, the password processor 240 may allow access to the corresponding data. If the second password is input through a user interface for releasing the direct access to the specific data, the password processor 240 may delete the data or may block access to the data.

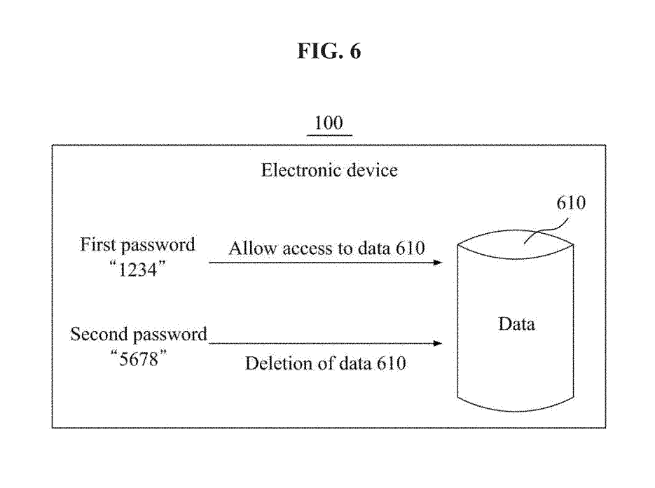

FIG. 6 illustrates a third example of protecting data by deleting the data according to at least one example embodiment. FIG. 6 illustrates an example of the electronic device 100 on which specific data 610 is stored. Referring to the example of FIG. 6, to access the data 610 stored on the electronic device 100, “1234” is set as a first password and “5678” is set as a second password.

If a password input to access the data 610 is “1234”, the electronic device 100 may allow access to the data 610. On the contrary, if the input password is “5678”, the electronic device 100 may delete the data 610. For example, a folder that includes the data 610 may be encrypted. The electronic device 100 may allow access to the data 610 by decrypting the encrypted folder and by providing the decrypted folder in response to the input of the password “1234”. The electronic device 100 may prevent leakage of the data 610 by deleting the data 610 from the folder, then providing the folder from which the data 610 is deleted in response to the input of the password “5678”. As another example, the file that includes the data 610 may be encrypted. In this case, the electronic device 100 may allow access to the data 610 by decrypting the encrypted file and by providing the decrypted file in response to the input of the password “1234”. On the contrary, the electronic device 100 may prevent leakage of the data 610 by providing an empty file from which the data 610 is deleted in response to the input of the password “5678”.

Examples of deleting data in response to an input of a second password are described above. Hereinafter, examples of blocking access to data in response to an input of the second password are described.

In operation 310 of FIG. 3, the first password setter 210 may generate a predetermined or desired character string for encrypting data stored on the electronic device 100 and may encrypt data to be protected using the generated character string. Here, when the generated character string is stored as is on the electronic device 100, the character string may be easily leaked. Thus, the first password setter 210 may generate a result value of an operation according to a first function using the first function having the character string and the first password as parameters and may store the generated result value on the electronic device 100. Here, when the first password is input in operation 330, the password processor 240 may restore the character string using a second function having the first password and the result value stored on the electronic device 100 as parameters in operation 340. Here, the first function and the second function may generate a result value or may restore a character string using operations having an inverse operation relationship with respect to each other. For example, the first function (A, B) may be a function that generates a result value C by processing a first operation between A and B (for example, an operation of A+B), and the second function (C, B) may be a function that restores A by processing a second operation having an inverse operation relationship with the first operation between C and B (for example, an operation of C-B using a subtraction operation having an inverse operation relationship with an add operation).

Here, the password processor 240 may allow access to data by decrypting the encrypted data using the restored character string. Here, the character string for encryption and decryption of data may be present on a memory of the electronic device 100 and may not be separately stored on the electronic device 100. Accordingly, the character string used as a key for encryption and decryption of data may be very securely protected.

In the meantime, if the second password is input, the password processor 240 may delete the result value stored on the electronic device 100. In this case, the electronic device 100 may release the screen lock function or the lock function of the specific application installed on the electronic device 100. However, since the stored result value is deleted, the character string for encryption and decryption of the data may not be leaked and access to the data may be blocked.

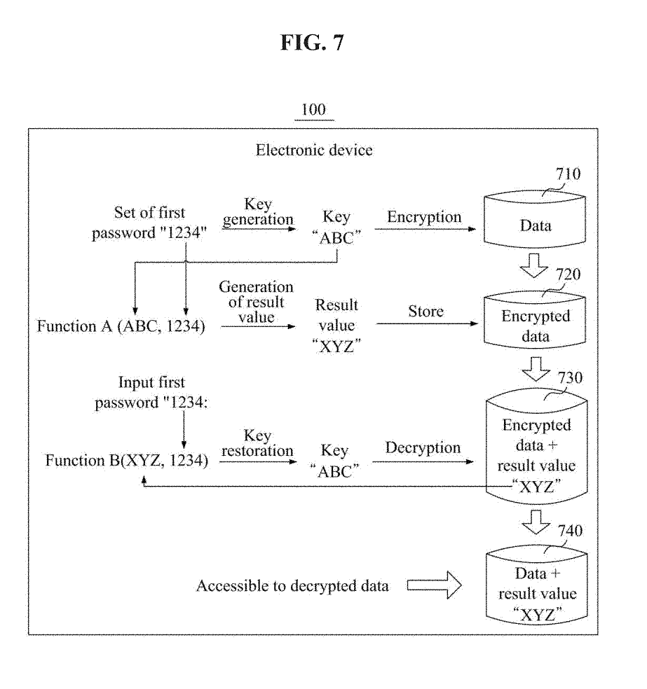

FIG. 7 illustrates an example of a process of allowing access to data according to at least one example embodiment. Referring to FIG. 7, if a first password “1234” is set, the first password setter 210 may generate a key “ABC” such as a predetermined or desired character string and may encrypt data 710 using the generated key “ABC”. Here, the electronic device 100 includes only encrypted data 720. Also, the first password setter 210 may generate a result value “XYZ” of a first operation (for example, a preset function A having the key “ABC” and the first password “1234” as parameters) between the key “ABC” and the first password “1234”, and may store the generated result value “XYZ”. In this case, the electronic device 100 may include [encrypted data+result value “XYZ” ] 730. Here, if the first password “1234” is input, the password processor 240 may restore the key “ABC” as a result value of a second operation (for example, a preset function B having the result value “XYZ” and the first password “1234” as parameters) between the stored result value “XYZ” and the first password “1234”. As described above, the first operation and the second operation may have an inverse operation relationship with respect to each other. In this case, the password processor 240 may decrypt the encrypted data using the restored key “ABC”, and the electronic device 100 may include [data+result value “XYZ” ] 740. Accordingly, the restored data may be accessible through the electronic device 100.

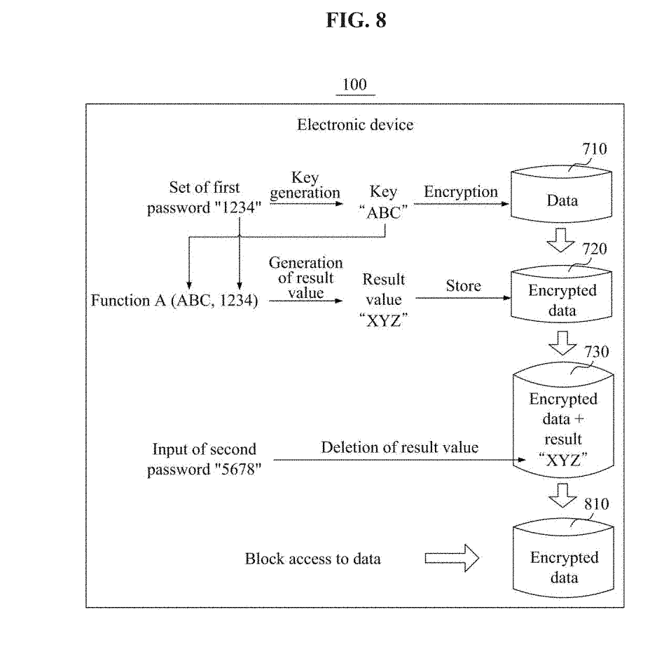

FIG. 8 illustrates an example of a process of blocking access to data according to at least one example embodiment. As described above with reference to FIG. 7, if the first password “1234” is set, the first password setter 210 may generate the key “ABC” such as a predetermined or desired character string and may encrypt the data 710 using the generated key “ABC”. Here, the electronic device 100 includes only the encrypted data 720. Also, the first password setter 210 may generate the result value “XYZ” of the first operation (for example, the preset function A having the key “ABC” and the first password “1234” as parameters) between the key “ABC” and the first password “1234”, and may store the generated result value “XYZ”. In this case, the electronic device 100 may include [encrypted data+result value “XYZ” ] 730.

Here, if a set second password “5678” is input, the password processor 240 may delete the stored result value “XYZ”. In this case, the electronic device 100 includes only encrypted data 810 and a method capable of decrypting the encrypted data 810 becomes absent. Accordingly, access to data through the electronic device 100 is blocked and the data may be protected. If complete deletion of the data is desired, the password processor 740 may prevent decryption of the encrypted data 810 by quickly deleting the result value “XYZ” and may proceed with deletion of the encrypted data 810.

In this case, the user of the electronic device 100 may not access the data of the electronic device 100. Accordingly, a method capable of restoring the encrypted data 810 after overcoming a coercive situation is desirable.

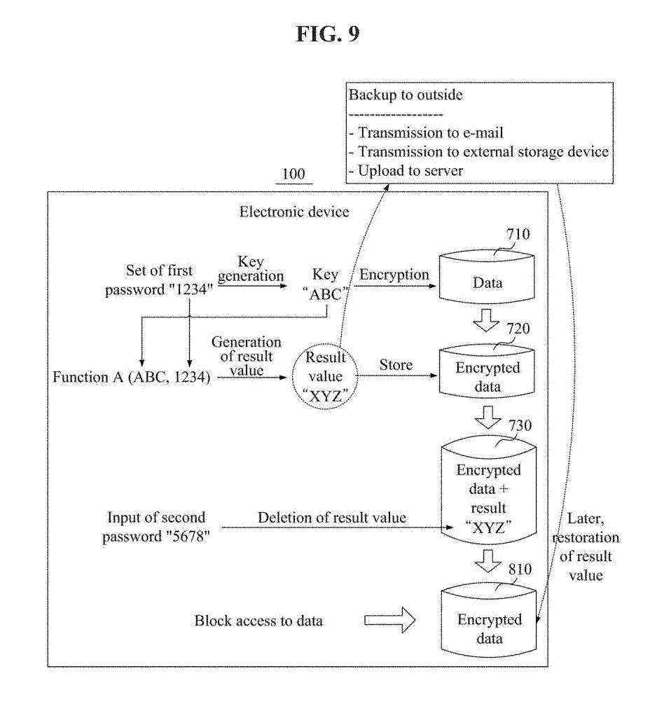

FIG. 9 illustrates an example of a result value backup process according to at least one example embodiment. As described above with reference to FIG. 8, when the result value “XYZ” is deleted in response to the input of the second password, access to data through the electronic device 100 may be blocked and the data may be protected. On the other hand, the encrypted data 810 may not be restored and the user of the electronic device 100 may lose such data. To prevent loss of data, the example embodiment of FIG. 9 may provide a function of transmitting the result value “XYZ” to the outside of the electronic device 100 and may transmit a generated private key to the outside of the electronic device 100. For example, the first password setter 210 may generate the result value “XYZ”, may store the generated result value “XYZ”, and may back up the result value “XYZ” by transmitting the generated result value “XYZ” to a preset e-mail address, by transmitting the result value “XYZ” to an external storage device such as a universal serial bus (USB) memory, or by uploading the result value “XYZ” to a preset server. For example, when setting the first password, the first password setter 210 may request the user for an e-mail address for backing up the result value “XYZ”, may receive the e-mail address, and may transmit and back up the generated result value “XYZ” to the received e-mail address. As another example, the first password setter 210 may request the user to connect an external storage device to the electronic device 100, and may transmit and back up the generated result value “XYZ” to the requested external storage device. As another example, the first password setter 210 may transmit and back up the generated result value “XYZ” to a server that is preset in association with an application for protecting data of the electronic device 100.

In this case, the user may input again the backed up result value “XYZ” to the electronic device 100 after overcoming a coercive situation, and may restore the result value “XYZ” from the electronic device 100. Here, as described above with reference to FIG. 7, if the first password “1234” is input, the password processor 240 may restore the key “ABC” using the result value “XYZ” and the first password “1234” and may restore the encrypted data 810. Accordingly, access to the data through the electronic device 100 may be allowed.

According to another example embodiment, access to data may be blocked without deleting the result value “XYZ”.

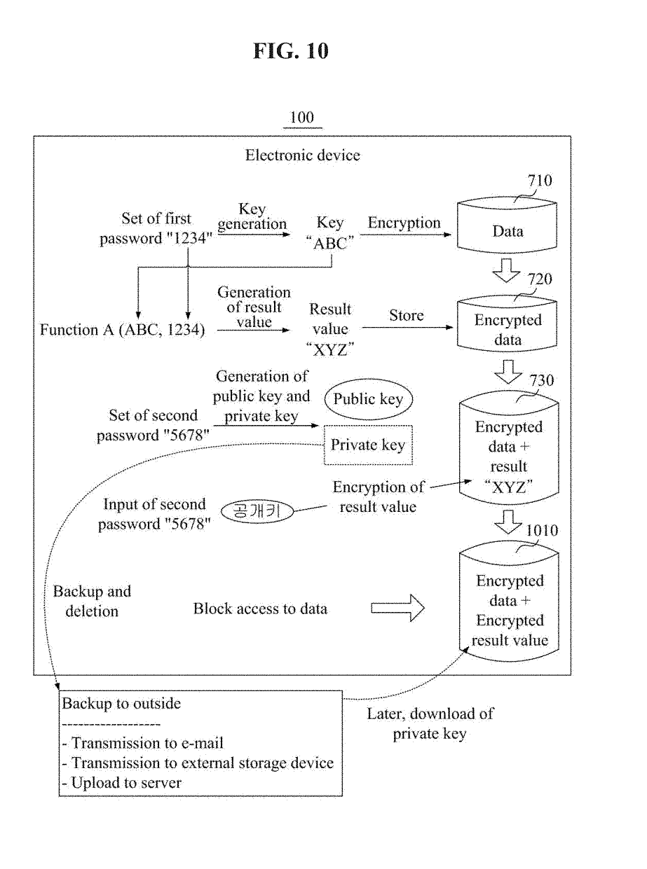

FIG. 10 illustrates an example of a process of blocking access to data using a pair of a public key and a private key according to at least one example embodiment. As described above with reference to FIG. 7, if the first password “1234” is set, the first password setter 210 may generate the key “ABC” such as a predetermined or desired character string and may encrypt the data 710 using the generated key “ABC”. Here, the electronic device 100 includes only the encrypted data 720. Also, the first password setter 210 may generate the result value “XYZ” of the first operation (for example, the preset function A having the key “ABC” and the first password “1234” as parameters) between the key “ABC” and the first password “1234”, and may store the generated result value “XYZ”. In this case, the electronic device 100 may include [encrypted data+result value “XYZ” ] 730.

In the meantime, if the second password “5678” is set, the second password setter 220 may generate a pair of a public key and a private key separate from the key “ABC”, and the first password and the second password. Here, the second password setter 220 may provide a function of transmitting the generated private key to the outside of the electronic device 100, may transmit the generated private key to the outside of the electronic device 100, and may store only the public key on the electronic device 100. Here, the function of transmitting the private key to the outside of the electronic device 100 may include a function of backing up the private key by transmitting the private key to a preset e-mail address, by transmitting the private key to the external storage device connected to the electronic device 100, or by uploading the private key to a preset server, and deleting the generated private key.

If the second password “5678” is input, the password processor 240 may encrypt the result value “XYZ” using the generated public key. In this case, the electronic device 100 may include [encrypted data+encrypted result value] 1010. Since the private key for decrypting the encrypted result value is absent in the electronic device 100, the electronic device 100 may not acquire the result value “XYZ” and may not acquire the key “ABC”, and accordingly, may not decrypt the encrypted data.

If the user downloads the private key to the electronic device 100 after overcoming the coercive situation, the password processor 240 may acquire the result value “XYZ” by decrypting the encrypted result value using the downloaded private key, and may acquire the key “ABC” using the result value “XYZ” and the first password “1234”, and accordingly, may decrypt the encrypted data using the key “ABC” and may access the data.

Examples of generating and utilizing the result value “XYZ” using the key “ABC” and the first password “1234” are described with reference to the example embodiments. However, depending on example embodiments, the key “ABC” may be stored and used.

In operation 310 of FIG. 3, the first password setter 210 may encrypt data using the key generated in association with the first password. Here, the key may be generated based on a value of the first password and may be generated as a random value regardless of the value of the first password. For example, a random string may be generated as the key. When the first password is input through the user interface provided in operation 330, the password processor 240 may restore data by decrypting the encrypted data using the generated key and may allow access to the data in operation 340. For example, the first password setter 210 may generate, as the key, an operation result that is acquired by inputting the first password as a parameter of a uni-directional function (for example, a hash function) incapable of restoring an original value. Here, the first password setter 210 may encrypt the data using the generated key. Also, if the first password is input, the password processor 240 may decrypt the encrypted data using the key. Accordingly, the encrypted data may be decrypted and access to the decrypted data may be allowed.

If the second password is input, the password processor 240 may delete the key. In this case, since the key for decrypting the encrypted data is deleted, the encrypted data may not be restored and access to the data may be blocked.

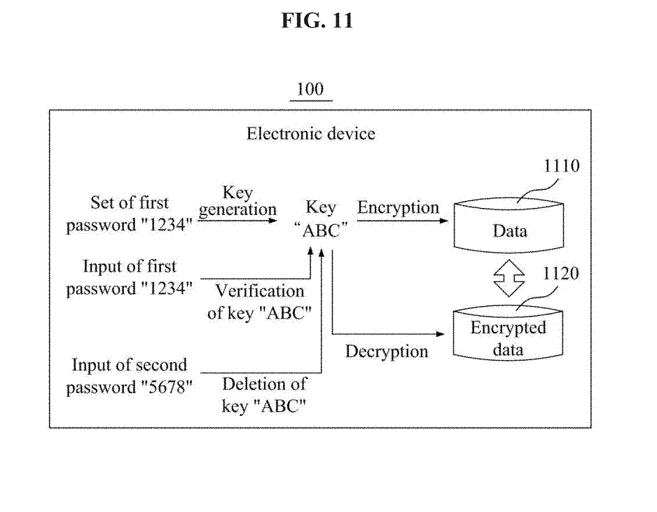

FIG. 11 illustrates an example of a process of blocking access to data by deleting a key according to at least one example embodiment. FIG. 11 illustrates an example of the electronic device 100 on which data 1110 is stored. If a first password “1234” is set, the electronic device 100 may generate a key “ABC” using “1234”. Here, “ABC” is only a name of the generated key and a value of the key may vary based on the first password. As another example, the generated key “ABC” may be merely associated with the first password “1234” and may be generated regardless of “1234” that is the value of the first password. For example, as described above, a random string may be generated as the key “ABC”. In this case, the electronic device 100 may encrypt the data 1110 using the generated key “ABC”. In this case, the electronic device 100 includes encrypted data 1120.

If a password input to the electronic device 100 is the first password “1234”, the electronic device 100 may acquire the data 1110 by decrypting the encrypted data 1120 using the key “ABC” associated with the first password “1234” and may allow access to the data 1110. On the contrary, if the password input to the electronic device 100 is a second password “5678”, the electronic device 100 may delete the generated key “ABC”. In this case, since a method of accessing the encrypted data 1120 is absent, the data 1110 may not be acquired.

If the set second password is to release a screen lock function of the electronic device 100, the screen lock function may be released after deleting the key “ABC”. If the set second password is to release a lock function of a specific application, the lock function of the specific application may be released after deleting the key “ABC”.

Depending on example embodiments, the encrypted data 1120 may be deleted after deleting the key “ABC” to completely delete the data 1110. It is to consider an amount of time used to delete the encrypted data 1120 based on capacity of the encrypted data 1120. Since the key “ABC” having relatively small capacity is deleted first, the data 1110 may not be restored as soon as the second password is input. Accordingly, it is possible to initially prevent acquirement of the data 1110 and to securely delete the encrypted data 1120.

Meanwhile, if the key “ABC” is completely deleted, it is impossible to restore the encrypted data 1120. Thus, to prepare for a case in which the user is deviated from the coercive situation and is in a safe situation, the key “ABC” may be transmitted to the outside of the electronic device 100 and thereby backed up before deleting the key “ABC”. For example, the password processor 240 may back up a generated key by transmitting the generated key to a preset e-mail address, by transmitting the generated key to an external storage device connected to the electronic device 100, or by uploading the generated key to a preset server, before deleting the generated key.

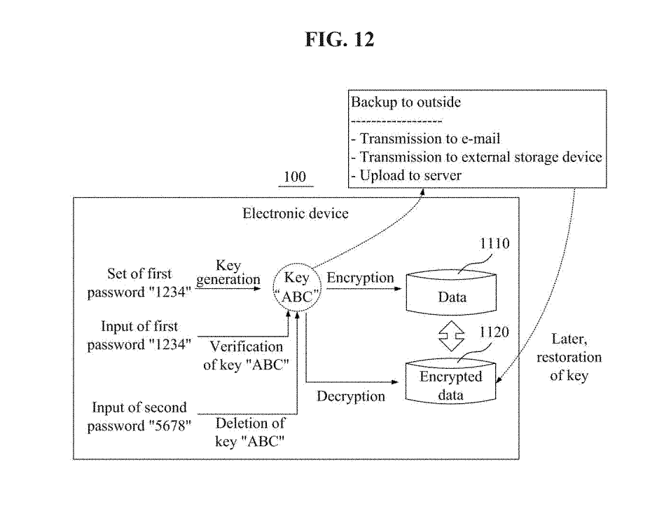

FIG. 12 illustrates an example of a key backup process according to at least one example embodiment. FIG. 12 illustrates an example of backing up the key “ABC” generated in FIG. 11 to the outside of the electronic device 100 for backup before deleting the key “ABC”. For example, if the key “ABC” is generated and a second password is set, a probability that the key “ABC” is deleted in response to an input of the second password occurs. Here, the electronic device 100 may provide a function of backing up the generated key “ABC” to the outside of the electronic device 100. Through this function, the user of the electronic device 100 may back up the key “ABC” by transmitting the generated key “ABC” to a preset e-mail address, by transmitting the generated key “ABC” to an external storage device such as a USB memory, or by uploading the generated key “ABC” to a preset server. Accordingly, although the key “ABC” is deleted in response to the input of the second password, the user may restore the encrypted data 1120 as the data 1110 by inputting again the backed up key “ABC” to the electronic device 100.

According to another example embodiment, access to the data 1110 may be blocked without deleting the key “ABC”.

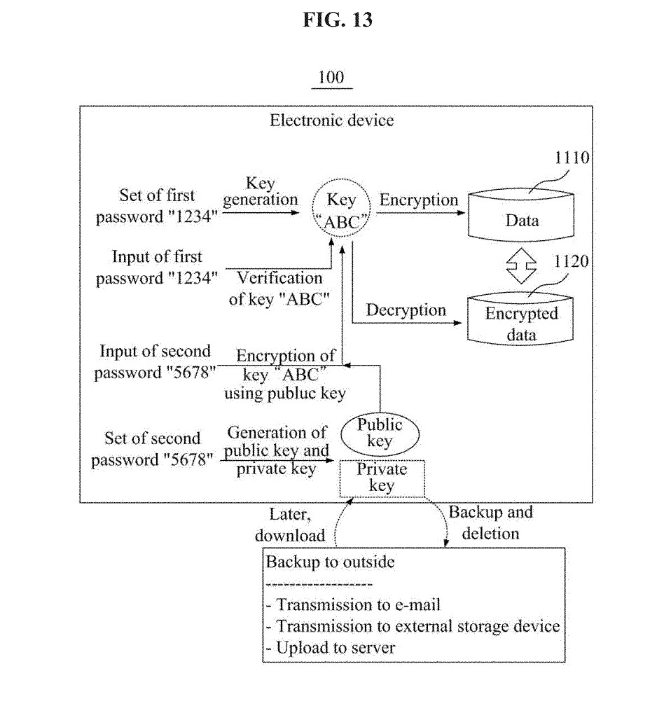

FIG. 13 illustrates an example of a process of encrypting a key using a public key and a private key according to at least one example embodiment.

As described above, the first password setter 210 may generate the key “ABC” in association with the first password and may encrypt the data 1110 using the generated key “ABC”. In this case, the electronic device 100 includes the encrypted data 1120. Here, if the input password is the first password, the electronic device 100 may acquire the data 1110 by verifying the key “ABC” and by decrypting the encrypted data 1120 using the verified key “ABC”.

Meanwhile, if the second password is set, the second password setter 220 may generate the first password and the second password, and a pair of a public key and a private key separate from the key “ABC”. Here, the second password setter 220 may transmit the generated private key to the outside of the electronic device 100 by providing a function of transmitting the private key to the outside of the electronic device 100, and may store only the public key on the electronic device 100. Here, the function of transmitting the private key to the outside of the electronic device 100 may include a function of backing up the private key by transmitting the private to the preset e-mail address, by transmitting the private key to the external storage device connected to the electronic device 100, or by uploading the private key to the preset server, and deleting the generated private key. Accordingly, the electronic device 100 may store only the public key from the generated pair of the public key and the private key.

Here, if the first password is input, the password processor 240 may allow access to the data 1110 by decrypting the encrypted data 1120 that is encrypted through the key “ABC” using the key “ABC”. In the meantime, if the second password is input, the password processor 240 may not allow the encrypted data 1120 to be decrypted by encrypting the key “ABC” using the public key. The key “ABC” encrypted using the public key may be acquired using the private key. However, since the private key is not stored on the electronic device 100, the key “ABC” may not be acquired and access to the data 1110 may be blocked.

If the electronic device 100 acquires the backed up private key again, the key “ABC” encrypted using the public key may be acquired. Accordingly, the data 1110 may be acquired by decrypting the encrypted data 1120.

According to another example embodiment, the password processor 240 may control the electronic device 100 to display a preset screen not in interaction with the input to the electronic device 100 while deleting data or blocking access to the data in response to the input of the second password. For example, in the example embodiment of releasing the lock function of the specific application, the electronic device 100 may displaying the preset screen and at the same time, may delete the data or block access to the data in response to the input of the second password. The preset screen may be a screen that enables a user viewing the screen to perceive as if the lock function of the application or the screen lock function of the electronic device 100 is normally released in response to the input of the second password.

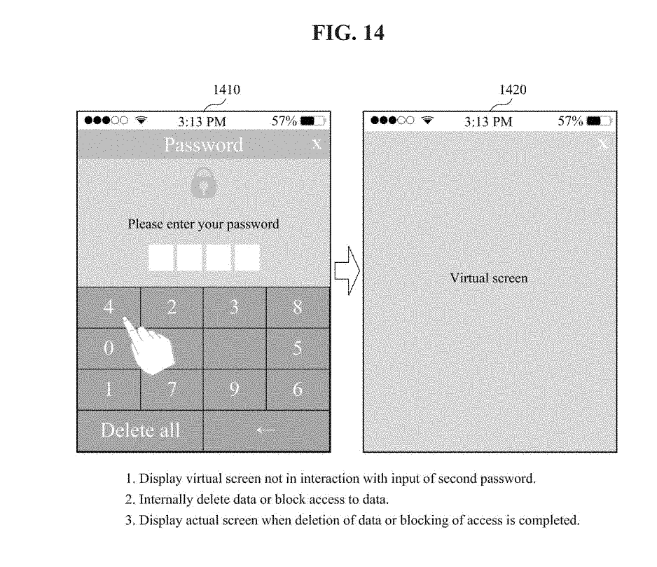

FIG. 14 illustrates an example of a password input screen and a virtual screen according to at least one example embodiment. A first screen 1410 is an example of a user interface for inputting a password. If a first password is input through the first screen 1410, a screen lock function of the electronic device 100 may be normally released and a main screen of the electronic device 100 or a preset screen may be displayed. Alternatively, a lock function of an application may be released and a service screen for the application may be displayed. A second screen 1420 is an example of displaying a virtual screen not in interaction with the input in response to an input of a second password. That is, since releasing of the screen lock function or the lock function of the application in response to the input of the second password is performed after data deletion or blocking access to the data is completed, the preset virtual screen may be temporarily displayed until the screen lock function or the lock function of the application is substantially released, such that a user viewing the virtual screen may perceive as if the lock function of the application or the screen lock function is normally released. Once the data deletion or the access blockage is completed, the second screen 1420 may be switched to an actual screen corresponding to releasing the screen lock function or the lock function of the application.

As described above, data managed by the data management method and the data management system may be data that is maintained by an application installed and executed on the electronic device 100. For example, in the case of a chat application, data, such as information about a friend relationship of a user, information about conversations of the user, information about photos, videos, links, files, contents, etc., transmitted and/or received by the user through the chat application, and information about purchase record through the chat application, may be managed. In this case, the electronic device 100 may process the input password under control of the corresponding application. Here, every time the application is executed in a foreground; the user interface provider 230 may provide a user interface and may request an input of a password. That is, in addition to a case in which the application is in operation, the user may be requested to input a password when the application is executed in a background and then executed in the foreground again.

According to another example embodiment, the second password setter 220 may set at least a portion of data in association with the second password. For example, in the case of the chat application, the second password setter 220 may set only information about conversations in association with the second password, or may designate only data of a specific section of the entire data or data included a specific folder in association with the second password. In this case, in response to the input of the second password, the password processor 240 may delete at least a portion of the data set in association with the second password or may block access thereto. That is, when setting the second password, the electronic device 100 may delete or block access to data designated by the user in response to the input of the second password.

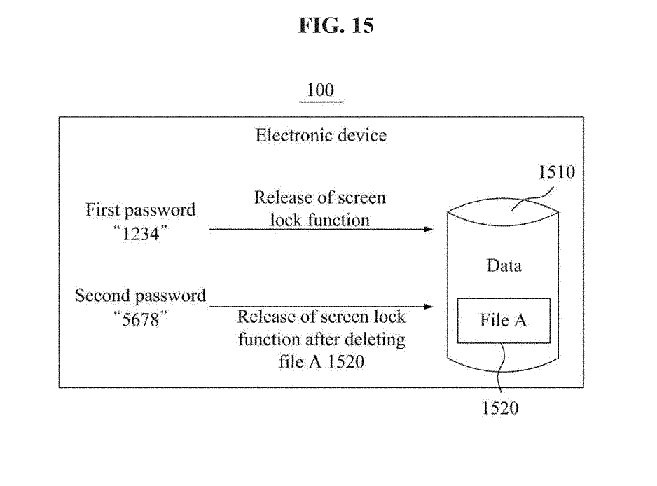

FIG. 15 illustrates an example of deleting a portion of data according to at least one example embodiment. FIG. 15 illustrates an example of the electronic device 100 on which data 1510 is stored. Referring to the example of FIG. 15, to release a screen lock function of the electronic device 100, “1234” is set as a first password and “5678” is set as a second password. Also, a file A 1520 is designated as data for deleting the data 1510 while setting the second password.

If “1234” is input as a password for releasing the screen lock function, the first password is input. Thus, the electronic device 100 may release the screen lock function and may allow access to the data 1510. On the contrary, if “5678” is input as the password for releasing the screen lock function, the second password is input. Thus, the electronic device 100 may delete the file A 1520 designated in association with the second password and then release the screen lock function. Accordingly, it is possible to prevent leakage of the file A 1520 from the data 1510.

According to another example embodiment, the second password setter 220 may set a plurality of different second passwords. In this case, in response to an input of at least one of the plurality of different second passwords, the password processor 240 may delete data or block access to the data. For example, the plurality of different second passwords may be used to prevent brute force cracking. For example, if a four-digit number is used as a password, a total of 10,000 passwords from 0000 to 9999 may be present. An attacker may attempt to crack a password by inputting a password sequentially starting with 0000 or in inverse order from 9999. Also, the attacker may attempt to crack a password using known numbers, such as a birthday, an anniversary, etc., of the user. Here, the plurality of second passwords may increase a probability that data is deleted or access to the data is blocked against the brute force cracking.

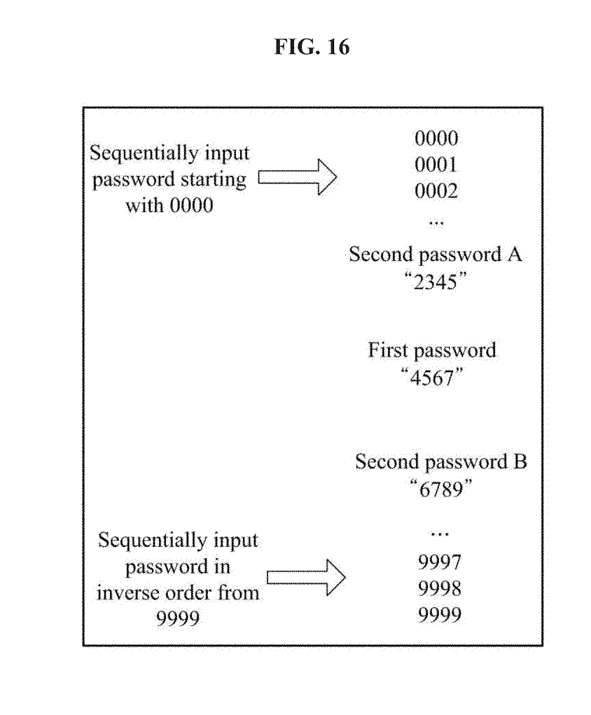

FIG. 16 illustrates an example of using a plurality of second passwords according to at least one example embodiment. In FIG. 16, it is assumed that a first password is set as “4567”, a second password A is set as “2345”, and a second password B is set as “6789”. The second password A and the second password B correspond to the plurality of second passwords. If an attacker inputs a password sequentially from 0000, “2345” may be input before “4567”. Thus, data may be deleted or access to the data may be blocked before cracking the first password. Inversely, if the attacker inputs a password in inverse order from 9999, “6789” may be input before “4567”. Thus, data may be deleted or access to the data may be blocked before cracking the first password. Accordingly, it is possible to prevent the brute force cracking of sequentially inputting all of passwords.

Also, by setting, as the plurality of second passwords, passwords that the attacker may easily predict, such as a birthday or an anniversary day, it is possible to delete data or to block access to the data although an easily predictable password is input.

According to example embodiments, it is possible to protect data using a second password even in a coercive situation in which the user is to speak a password by setting a first password for allowing access to an electronic device, a specific application, or specific data and the second password for deleting specific data desired to be protected or blocking access to the specific data, and by deleting the specific data or blocking access to the specific data in response to an input of the second password.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that store and perform program instructions, such as read-only memory (ROM, random access memory (RAM, flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-transitory computer-readable recording medium storing instructions that, when executed by a processor, cause the processor to perform data management operations in conjunction with an electronic device configured as a computer, the data management operations comprising:
setting a first password for allowing access to data stored on the electronic device,
setting a second password for deleting the data or blocking access to the data,
providing a user interface for inputting a password, and
processing the input password by allowing access to the data in response to an input of the first password through the user interface or by deleting the data or blocking access to the data in response to an input of the second password through the user interface.

2. The non-transitory computer-readable recording medium of claim 1, wherein
the setting of the first password includes encrypting the data using a key generated as a desired character string and storing a result value of a first operation between the desired character string and the first password,
the processing of the input password includes allowing access to the data by restoring the key using a result of a second operation between the stored result value and the first password in response to the input of the first password, and by restoring the encrypted data using the restored key, and
the first operation and the second operation have an inverse operation relationship.

3. The non-transitory computer-readable recording medium of claim 2, wherein the processing of the input password includes blocking access to the data by deleting the stored result value in response to the second password being input.

4. The non-transitory computer-readable recording medium of claim 3, wherein the processing of the input password includes backing up the result value by transmitting the generated key to an e-mail address or an external storage device connected to the electronic device, or by uploading the generated key to a server, before deleting the stored result value.

5. The non-transitory computer-readable recording medium of claim 3, wherein the processing of the input password includes deleting the encrypted data after deleting the stored result value in response to the input of the second password.

6. The non-transitory computer-readable recording medium of claim 1, wherein
the setting of the first password includes encrypting the data using a key generated as a desired character string and storing a result value of a first operation between the desired character string and the first password,
the setting of the second password includes generating a pair of a public key and a private key separate from the second password, providing a function of transmitting the private key to an outside of the electronic device, and storing the public key on the electronic device, and
the processing of the input password includes blocking access to the data by encrypting the stored result value using the public key in response to the input of the second password.

7. The non-transitory computer-readable recording medium of claim 1, wherein
the setting of the first password includes encrypting the data using a key generated in association with the first password, and
the processing of the input password includes allowing access to the data by decrypting the encrypted data using the generated key in response to the input of the first password, and blocking access to the data by deleting the generated key in response to the input of the second password.

8. The non-transitory computer-readable recording medium of claim 1, wherein
the setting of the first password includes encrypting the data using a key generated in association with the first password,
the setting of the second password includes generating a pair of a public key and a private key separate from the second password, providing a function of transmitting the private key to an outside of the electronic device, and storing the public key on the electronic device, and
the processing of the input password includes allowing access to the data by decrypting the encrypted data using the key generated in association with the first password in response to the input of the first password, and blocking access to the data by encrypting the key generated in association with the first password using the public key in response to the input of the second password.

9. The non-transitory computer-readable recording medium of claim 1, wherein the processing of the input password includes displaying a preset screen not in interaction with the input to the electronic device while deleting the data or blocking access to the data in response to the input of the second password.

10. The non-transitory computer-readable recording medium of claim 1, wherein
the data includes data that is managed by an application installed and executed on the electronic device, and
the processing of the input password includes processing the input password under control of the application.

11. The non-transitory computer-readable recording medium of claim 10, wherein the providing of the user interface includes providing the user interface and requesting the input of the password every time the application is executed in a foreground.

12. The non-transitory computer-readable recording medium of claim 1, wherein
the setting of the second password comprises setting a portion of the data in association with the second password, and
the processing of the input password includes deleting at least the portion of the data set in association with the second password or blocking access to at least the portion of the data set in association with the second password, in response to the input of the second password.

13. The non-transitory computer-readable recording medium of claim 1, wherein
the setting of the second password includes setting a plurality of different second passwords, and
the processing of the input password includes deleting the data or blocking access to the data in response to an input of at least one of the plurality of different second passwords.

14. The non-transitory computer-readable recording medium of claim 1, wherein the first password includes a password for allowing access to the data by allowing use of the electronic device, a password for allowing access to the data by allowing execution of a specific application installed on the electronic device, or a password for allowing direct access to the data.

15. A data management method executed by an electronic device configured as a computer, the method comprising:
setting a first password for allowing access to data stored on the electronic device;
setting a second password for deleting the data or blocking access to the data;
providing a user interface for inputting a password; and
processing the input password by allowing access to the data in response to an input of the first password through the user interface or by deleting the data or blocking access to the data in response to an input of the second password through the user interface.

16. The method of claim 15, wherein
the setting of the first password includes encrypting the data using a key generated as a desired character string and storing a result value of a first operation between the desired character string and the first password,
the processing of the input password includes allowing access to the data by restoring the key using a result of a second operation between the stored result value and the first password in response to the input of the first password, and by restoring the encrypted data using the restored key, and
the first operation and the second operation have an inverse operation relationship.

17. The method of claim 16, wherein the processing of the input password includes blocking access to the data by deleting the stored result value in response to the input of the second password.

18. The method of claim 15, wherein
the setting of the first password includes encrypting the data using a key generated as a desired character string and storing a result value of a first operation between the desired character string and the first password,
the setting of the second password includes generating a pair of a public key and a private key separate from the second password, providing a function of transmitting the private key to an outside of the electronic device, and storing the public key on the electronic device, and
the processing of the input password includes blocking access to the data by encrypting the stored result value using the public key in response to the input of the second password.

19. The method of claim 15, wherein the setting of the first password includes encrypting the data using a key generated in association with the first password, and
the processing of the input password includes allowing access to the data by decrypting the encrypted data using the generated key in response to the input of the first password, and blocking access to the data by deleting the generated key in response to the input of the second password.

20. The method of claim 15, wherein
the setting of the first password includes encrypting the data using a key generated in association with the first password,
the setting of the second password includes generating a pair of a public key and a private key separate from the second password, providing a function of transmitting the private key to an outside of the electronic device, and storing the public key on the electronic device, and
the processing of the input password includes allowing access to the data by decrypting the encrypted data using the key generated in association with the first password in response to the input of the first password, and blocking access to the data by encrypting the key generated in association with the first password using the public key in response to the input of the second password.
